(19) United States
(12) Patent Application Publication
(10) Pub. No.: US 2015/0096933 A1
(43) Pub. Date: Apr. 9, 2015

(54) Filtration Article Having Thermoplastic Filled Edges

(71) Applicant: W. L. Gore & Associates, Inc., Newark, DE (US)

(72) Inventor: Bradley Marshall McClary, Elkton, MD (US)

(73) Assignee: W. L. Gore & Associates, Inc., Newark, DE (US)

(21) Appl. No.: 14/047,064

(22) Filed: Oct. 7, 2013

(51) Int. Cl. B01D 29/00; B01D 29/31

(52) U.S. Cl. CPC B01D 29/0093; B01D 29/31
USPC 210/485; 210/490; 264/135

(57) ABSTRACT

A filtration article and a method for manufacture of the filtration article. The filtration article includes a filtration medium that includes a porous membrane. A thermoplastic end cap component is potted onto the filtration medium along the peripheral edge of the filtration medium. To enhance the quality of the seal between the end cap component and the filtration medium, a thermoplastic material is imbibed through at least a portion of the thickness of the filtration medium along the peripheral edge. Methods for the manufacture of such a filtration article and the filtration medium are also provided.

### TECHNICAL FIELD

This disclosure relates to the field of filtration articles, such as for the removal of undesirable contaminants from a fluid stream as the fluid stream passes through the filtration article.

### BACKGROUND

Porous membranes are widely used in the filtration of particulate, ionic, microbial and other contaminants from fluids in the pharmaceutical, microelectronics, chemical and food industries. In use, the membranes are formed into a device (e.g., pleated cartridges which may be housed within a capsule, hollow tubes, stack of flat disks, etc.) which is placed in the fluid stream to be filtered.

Many filtration devices are constructed entirely of fluoropolymer materials to meet chemical and temperature resistance requirements, such as for use in the fabrication of semiconductors. The continued trend towards narrower line widths in semiconductor manufacturing has placed an ever increasing burden on particulate contamination control in semiconductor fabrication. Such a trend has led to the introduction of fluoropolymer filtration membranes having rated pore sizes as low as 10 nm.

While such filtration membranes provide superior particle filtration, there is a desire to extend the life cycle, or time-in-use, of the membranes, while maintaining the filtration efficiency thereof. In this regard, in typical filtration implementations, a support layer may be positioned downstream of a fluoropolymer filtration membrane to support the membrane against the pressure of fluid flow. In addition, the support layer or another downstream layer may provide drainage functionality, e.g., by acting as a spacing layer with downstream passageways therethrough to facilitate fluid flow through the membrane. In that regard, an upstream drainage layer may also be utilized. For example, the support and/or drainage layers may be constructed of fluoropolymer fibers (e.g., filaments or yarns) in the form of a woven, non-woven or knit structure.

Filtration media including a fluoropolymer membrane may be implemented using a variety of structures and configurations. For example, the filtration medium is typically pleated to increase the effective filtration area. The pleated filtration medium is often formed into a cylinder and is housed within a filter cage. The ends of the filtration medium are typically sealed by potting the ends of the filtration medium in an end cap, the end cap being in the form of a resin, a molten thermoplastic, or the like during the potting step. The seal between the filtration medium and the potted end cap may be robust to avoid the formation of leak paths between the filtration medium and the end cap, which can lead to a failure of the filtration article.

### SUMMARY

It has been found to be particularly difficult to form a seal of high integrity between a filtration medium including a porous fluoropolymer membrane and a potted thermoplastic end cap, particularly when the filtration medium also includes a fibrous structure for support and/or drainage.

It is an objective to provide a filtration article and a method for the manufacture of a filtration article that includes a filtration medium having a porous fluoropolymer membrane and a potted thermoplastic end cap, where the seal between the filtration medium and the thermoplastic end cap has a high integrity, e.g., has a reduced likelihood of leak paths being formed between the filtration medium and the end cap.

In one embodiment, a filtration article for the filtration of particles from a fluid stream is provided. The filtration article may include a filtration medium having at least a first peripheral edge and a thermoplastic end cap component potted onto the filtration medium along the first peripheral edge. The filtration medium may include a first layer, positionable across the fluid stream, the first layer comprising a porous fluoropolymer membrane. The filtration medium may also include a second layer, positionable across the fluid stream, the second layer comprising a plurality of fluoropolymer fibers that are arranged to form a fibrous structure, the fibrous structure being selected from a woven structure, a nonwoven structure and a knit structure. A thermoplastic material may be imbibed through at least a portion of a thickness of the second layer fibrous structure along the first peripheral edge, and within a limited extent of a cross-dimension of the filtration medium.

In one characterization of this embodiment, the filtration medium may be pleated, e.g., having pleats extending along the cross-dimension of the filtration medium. In another characterization, the filtration medium may be configured as a closed cylinder. In yet another characterization, the thermoplastic material may be imbibed in a substantially continuous fashion along the first peripheral edge. The peripheral edge may correspond with a first end of the filtration medium. In this characterization, a second peripheral edge may be imbibed with the thermoplastic material through at least a portion of the thickness of the second layer fibrous structure and within a limited extent of the cross-dimension of the filtration medium. For example, the second peripheral edge may correspond with a second end of the filtration medium that is opposite the first end of the filtration medium, e.g., separated by the cross-dimension.

In one characterization, the porous fluoropolymer membrane comprises polytetrafluoroethylene (PTFE). In another characterization, the thermoplastic material may comprise (e.g., be fabricated from) a fluoropolymer. In one characterization, the thermoplastic material comprises fluoroethylene propylene (FEP). In another characterization, the thermoplastic material comprises perfluoroalkoxy (PFA). The thermoplastic end cap may also comprise a fluoropolymer, and in one characterization the thermoplastic end cap comprises PFA. In another characterization, the second layer is positioned adjacent to and downstream of the first layer to provide for at least support of the first layer. In another characterization, the filtration medium further comprises a third layer, positionable across the fluid stream, the third layer being disposed on an opposite side of the membrane from the second layer. The third layer may comprise a plurality of fluoropolymer fibers arranged to form a fibrous structure, the fibrous structure being selected from the group consisting of a woven structure, a nonwoven structure and a knit structure. The thermoplastic material may be imbibed through at least a portion of a thickness of the third layer fibrous structure along the first peripheral edge.

In one characterization, the thermoplastic material is imbibed substantially throughout the thickness of the second layer fibrous structure. In another characterization, the thermoplastic material is imbibed within the cross-dimension of the filtration medium by a distance of at least about 5 mm. In yet another characterization, the thermoplastic material is imbibed within the cross-dimension of the filtration medium by distance of not greater than about 100 mm. In another characterization, the thermoplastic material is imbibed within the cross-dimension past the thermoplastic end cap.

In a further characterization, the filtration article may comprise a thermoplastic material imbibed through at least a portion of a thickness of the second layer fibrous structure along a second peripheral edge, and a second thermoplastic end cap component potted onto the filtration medium along the second portion of the peripheral edge.

In another characterization, the thermoplastic material and the thermoplastic end cap component comprise different thermoplastics, such as where the melting point of the thermoplastic material is less than the melting point of the thermoplastic end cap component. In one particular characterization, the melting point of the thermoplastic material is not greater than about 300° C.

In another characterization, the filtration medium may be configured to remove particles having a size of about 25 nm and greater from the fluid stream.

In accordance with any of the foregoing embodiments and characterizations, the second layer fibrous structure and/or the third layer fibrous structure may comprise a knit structure.

According to another embodiment of this disclosure, a filtration device is provided. The filtration device may include a filter cage and a filter element disposed within the filter cage. The filter element may include a filtration article as described in any of the foregoing embodiments and various characterizations.

In a further embodiment of this disclosure, a method for the manufacture of a filtration article is provided. The method may include the steps of imbibing a filtration medium having at least a first peripheral edge with a thermoplastic material along the first peripheral edge and within a limited extent of a cross-dimension of the filtration medium. The method may also include a step of potting the filtration medium in a thermoplastic end cap component along the first peripheral edge.

In one characterization, the filtration medium comprises a first layer, positionable across a fluid stream, and comprises a porous fluoropolymer membrane. The filtration medium also comprises a second layer, also positionable across the fluid stream, the second layer comprising a plurality of fluoropolymer fibers that are arranged to form a fibrous structure, the fibrous structure being selected from a woven structure, a nonwoven structure and a knit structure. In one particular characterization, the second layer fibrous structure is a knit structure.

In another characterization of the foregoing method, the imbibing step may comprise the steps of contacting the filtration medium with a thermoplastic material along the first peripheral edge and heating the thermoplastic material to imbibe the first peripheral edge with the thermoplastic material. In one characterization, the contacting step may comprise disposing a strip of the thermoplastic material along the peripheral edge and in contact with the second layer. In a further characterization, the strip of thermoplastic may have a width of at least about 5 mm and not greater than about 100 mm. In yet another characterization, the contacting step may include co-extruding the thermoplastic material with the filtration medium.

In another characterization of the foregoing method, the method may include the step of pleating the filtration medium. For example, the filtration medium may be pleated before the potting step. In another characterization, the heating step may comprise heating the filtration medium and the thermoplastic material using heated platens during the pleating step. In this regard, the heated platens may plastically deform the thermoplastic material during the heating step.

In another characterization, the heating step may comprise heating the thermoplastic material to a temperature in excess of the melting temperature of the thermoplastic material. In a further characterization, the method may comprise allowing the heated thermoplastic material to cool to a temperature below the melting temperature of the thermoplastic material before the potting step.

In one characterization, the porous fluoropolymer membrane comprises PTFE. In another characterization, the thermoplastic material comprises FEP. In yet another characterization, the end cap component comprises PFA.

In another characterization, the potting step creates a seal between end cap component and the filtration medium. In another characterization, the method may further comprise the steps of imbibing the filtration medium with the thermoplastic material along at least a second peripheral edge of the filtration medium and within a limited extent of the cross-dimension of the filtration medium, and potting the filtration medium in a second thermoplastic end cap component along the second peripheral edge.

### DESCRIPTION OF THE DRAWINGS

FIG. 1A and FIG. 1B illustrate an exploded view of a filtration device including an embodiment of a filtration article.

FIG. 2 illustrates a perspective view of a filtration medium according to an embodiment.

FIG. 3 illustrates a cross-sectional view of a filtration medium illustrated in FIG. 2.

FIG. 4 illustrates a cross-sectional view of a filtration medium according to an embodiment.

FIG. 5 illustrates a cross-sectional view of a filtration medium according to an embodiment.

FIG. 6 illustrates another cross-sectional view of the filtration medium illustrated in FIG. 4.

FIG. 7 illustrates a perspective view of a pleated filtration medium according to an embodiment.

FIG. 8 illustrates a perspective view of a pleated filtration medium according to an embodiment.

FIG. 9 illustrates a perspective view of a filtration article including a filtration medium and end cap components according to an embodiment.

### DETAILED DESCRIPTION

According to the present disclosure, filtration articles and methods for the manufacture of filtration articles are set forth. The filtration articles include a filtration medium comprising a membrane fabricated from a fluoropolymer, such as porous polytetrafluoroethylene (PTFE). In one particular embodiment, the filtration medium is in the form of a pleated closed cylinder that may be mounted in a filtration device.

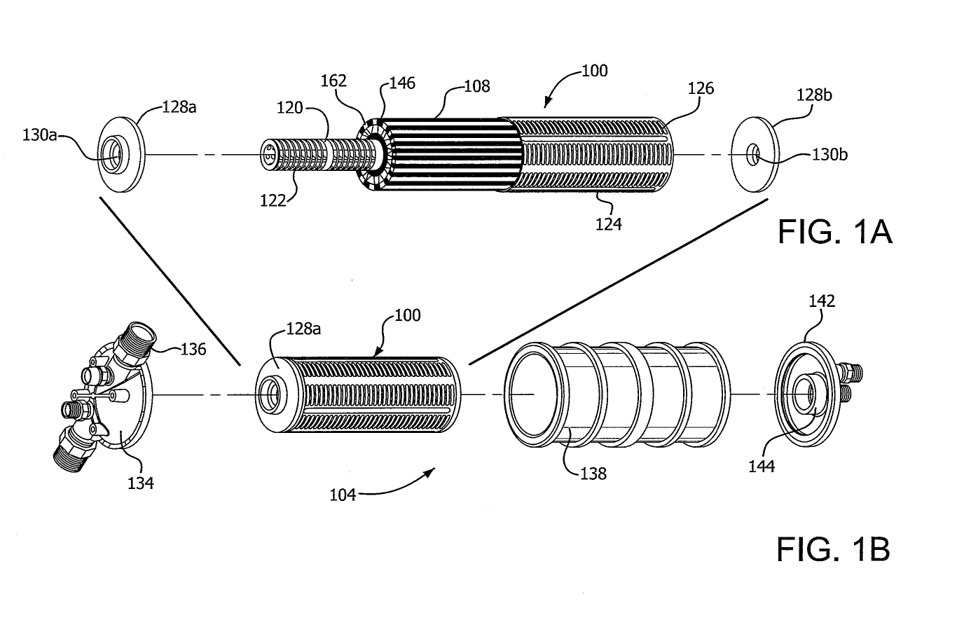

FIG. 1A and FIG. 1B illustrate exemplary components of a filtration device including a filtration article according to the present disclosure. A filtration article in the form of a cylindrical filtration cartridge 100 includes an outer cage 124 having a plurality of apertures 126 (e.g., perforations) through the surface of the cage 124 to enable fluid flow through the outer cage 124, e.g., laterally through the surface of the cage 124. A filtration medium 108 is disposed within the outer cage 124 e.g., concentrically disposed within the outer cage 124. In the embodiment illustrated in FIG. 1A, the filtration medium 108 is pleated and has a generally cylindrical configuration. The filtration medium 108 includes at least a first layer of a porous fluoropolymer membrane and at least a second layer that is configured to support the porous membrane and/or is configured to provide drainage of fluid away from the membrane. The filtration medium 108 further includes a thermoplastic material 146 that is imbibed (e.g., infiltrated) within the filtration medium 108 along at least a first end 162 of the filtration medium 108.

The filtration cartridge 100 also includes an inner core member 120 that is disposed within the cylindrical filtration medium 108. The inner core member 120 is also substantially cylindrical and includes apertures 122 to permit a fluid stream to flow through the inner core 120, e.g., laterally through the surface of the inner core 120. Thus, the filtration medium 108 is disposed (e.g., concentrically disposed) between the inner core member 120 and the outer cage 124.

The filtration cartridge 100 further includes end cap components 128a and 128b disposed at opposite ends of the filtration cartridge 100. The end cap components 128a and 128b include apertures 130a and 130b to permit fluid communication with the inner core 120. Thus, in one characterization, fluid may flow into the filtration cartridge 100 through apertures 130a and/or 130b, and into the inner core member 120. Under sufficient fluid pressure, fluid will pass through the apertures 122, through the filtration medium 108 and will exit the filtration cartridge 100 through the apertures 126 of the outer cage 124.

The components of the filtration cartridge 100, including the outer cage 124, the inner core member 120 and the end cap components 128a and 128b, may be fabricated from a fluoropolymer, and in particular may be fabricated from a thermoplastic fluoropolymer. Fluoropolymers are particularly useful for the filtration of chemically corrosive fluids, such as during semiconductor manufacture.

When the filtration cartridge 100 is assembled, as illustrated in FIG. 1B, end cap components 128a and 128b are potted onto the filtration medium 108 with the outer cage 124 and the inner core member 120 disposed between the end cap components 128a and 128b. That is, the end cap components 128a and 128b are sealed to the filtration medium 108 by heating the end cap components 128a and 128b to a temperature that is sufficient to cause the thermoplastic from which the end cap components are fabricated to soften and flow. When the thermoplastic is in the flowable state, the ends of the filtration medium 108 (e.g., end 162) are contacted with the respective end cap components 128a and 128b to cause the flowable thermoplastic to imbibe (e.g., to infiltrate) the filtration medium 108. Thereafter, the end cap components 128a and 128b are solidified (e.g., by cooling) to form a seal with the filtration medium 108.

The assembled filtration cartridge 100 (e.g., with the end cap components potted onto the filtration medium) may then be used in a filtration device such as a filtration capsule 104 as illustrated in FIG. 1B. To assemble the filtration capsule 104, the filtration cartridge 100 is disposed within a cylindrical barrel 138 and a barrel head 134 and a barrel bottom 142 are attached to the barrel 138, e.g., by welded engagement with the barrel 138. When so assembled, the head 134 and the bottom 142 also form a fluid seal with the filtration cartridge 100, such as through use of a flange (e.g., flange 144). The head 134 and the bottom 142 may be provided with various fluid inlet and outlet ports (e.g., fluid port 136) to direct the fluid flow out of or in to the filtration cartridge 100. In use, a fluid stream (e.g., a liquid stream) may be directed into the filtration cartridge 100, e.g., through the outer cage 124, through the filtration medium 108, and into the inner core member 120. The filtered fluid stream, having passed through the filtration medium 108, may then be extracted from the filtration capsule 104 through a fluid outlet port.

Those skilled in the art will recognize that various other configurations of filtration devices may be utilized in accordance with the present disclosure, such as non-cylindrical (e.g., planar) filtration devices. Further, although the flow of fluid is described as being from the outside of the filtration cartridge to the inside of the filtration cartridge (e.g., outside-in flow), it is also contemplated that in some applications fluid flow may occur from the inside of the filtration cartridge to the outside of the filtration cartridge (e.g., inside-out flow).

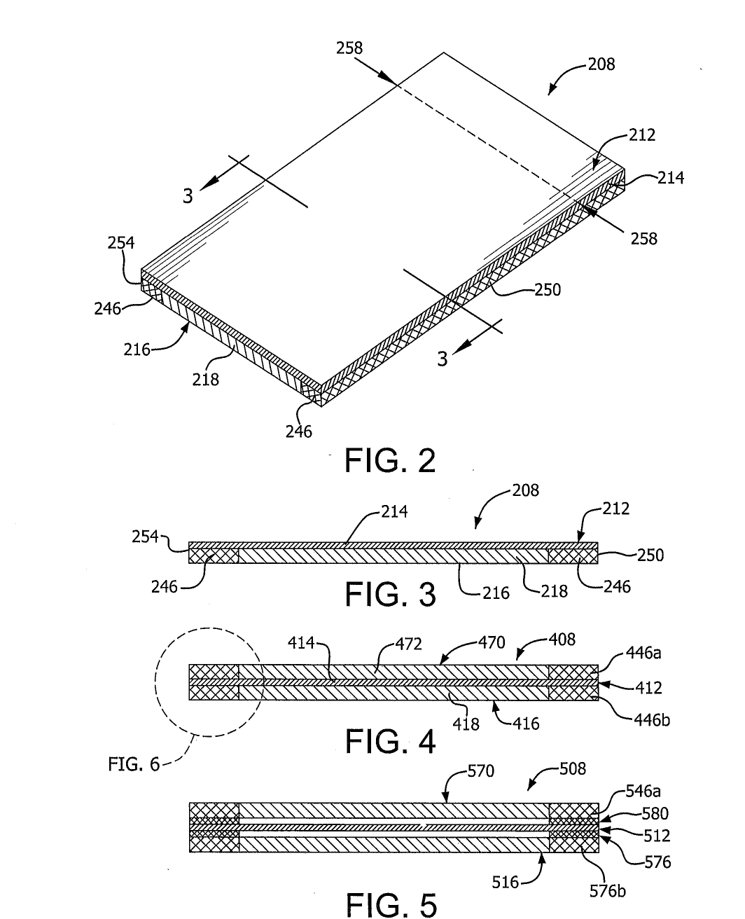

FIG. 2 illustrates a perspective view of a filtration medium according to an embodiment. The filtration medium 208 includes a first layer 212, where the first layer 212 comprises a porous membrane 214. The porous membrane 214 is configured to separate particles from a fluid stream when the membrane 214 is placed in the fluid stream. For example, the membrane 214 may have a pore size and pore size distribution that is configured to remove particles having a size (e.g., a diameter) of about 25 nm and greater from the fluid stream. The membrane 214 may comprise (e.g., be fabricated from) a fluoropolymer material, such as PTFE (polytetrafluoroethylene), for example an expanded PTFE prepared in accordance with the methods described in U.S. Pat. No. 7,306,729 by Bacino et al., U.S. Pat. No. 3,953,566 by Gore, U.S. Pat. No. 5,476,589 by Bacino, or U.S. Pat. No. 5,183,545 by Branca et al. The porous membrane 214 may also comprise an expanded polymeric material comprising a functional TFE (tetrafluoroethylene) copolymer material comprising a microstructure characterized by nodes interconnected by fibrils, where the functional TFE copolymer material comprises a functional copolymer of TFE and PSVE (perfluorosulfonyl vinyl ether), or TFE with another suitable functional monomer, such as, but not limited to, vinylidene fluoride (VDF). The functional TFE copolymer material may be prepared, for example, according to the methods described in U.S. Patent Publication No. 2010/0248324 by Xu et al. or U.S. Patent Publication No. 2012/035283 by Xu et al. It is to be understood that throughout the application, the term PTFE is also meant to include expanded PTFE, expanded modified PTFE, and expanded copolymers of PTFE, such as described in U.S. Pat. No. 5,708,044 by Branca, U.S. Pat. No. 6,541,589 by Baillie, U.S. Pat. No. 7,531,611 by Sabol et al., U.S. Patent Publication No. 2009/0093602 by Ford, and U.S. Patent Publication No. 2010/0248324 by Xu et al.

A second layer 216 is disposed adjacent the first layer 212 and includes a fibrous structure 218. A fibrous structure is a structure that comprises a plurality of fibers (e.g., fibers, filaments, yarns, etc.) that are formed into a cohesive structure. The fibrous structure 218 may be a woven structure, a nonwoven structure or a knit structure. In one particular embodiment, the fibrous structure is a knit structure. The fibrous structure 218 may provide support for the first layer 212 and/or may provide fluid drainage for the filtration medium 208. For example, when the fibrous structure 218 is placed downstream from the first layer 212, the fibrous structure 218 may provide support for the first layer 212 against the pressure of the fluid. The fibrous structure 218 may also act as a spacer to provide passageways for fluid flow through the filtration medium, e.g., to provide membrane drainage functionality. The fibrous structure 218 may be a knit structure that includes interlocking regions to yield enhanced stability and increase time-in-use attributes relative to known fluid filtration articles. The fibrous structure 218 may be fabricated from fibers (e.g., strands) of fluoropolymers, such as those selected from PTFE, FEP, PFA and polyvinylidene fluoride (PVDF). In one particular characterization, the fibers include PTFE fibers. By way of example, a PTFE knit layer is constructed from yarn having at least one PTFE fiber. The PTFE fiber may include oriented fibrils and may be non-porous or porous. The PTFE fiber may be a monofilament or it may be two different PTFE fibers having different deniers, density, length or dimensions. A multiple strand of yarn having at least one PTFE fiber and at least one other type of fluoropolymer fiber that is not PTFE may also be utilized in the fibrous structure 218.

A thermoplastic material 246 is imbibed through at least a portion of a thickness of the second layer 216 and along at least a first peripheral edge 250 of the filtration medium 208. As illustrated in the embodiment of FIG. 2, the thermoplastic material 246 is also imbibed along a second peripheral edge 254 of the filtration medium 208, where the second peripheral edge 254 is on an opposite side of the filtration medium from the first peripheral edge 250, i.e., separated by cross-dimension 258. The cross-dimension (e.g., transverse to the first peripheral edge 250 and the second peripheral edge 254) may be at least about 50 mm, and may be not greater than about 1200 mm. It will be appreciated, however, that in some configurations the thermoplastic material 246 may be imbibed along a single edge, e.g., along only the first peripheral edge 250.

The thermoplastic material 246 may also comprise a fluoropolymer, such as a fluoropolymer having a melting point that is not greater than about 300° C. Typically, the fluoropolymer will have a melting point of at least about 150° C. For example, the thermoplastic material may be selected from the group consisting of FEP, PFA, PVDF, perfluoro methyl alkoxy (MFA), and a terpolymer of TFE, hexafluoropropylene and vinylidene fluoride (THV). In one particular embodiment, the thermoplastic material comprises FEP. In another embodiment, the thermoplastic material comprises PFA.

FIG. 3 illustrates a cross-section of the filtration medium 208 illustrated in FIG. 2. The filtration medium 208 includes a first layer 212 comprising a porous membrane 214, and the second layer 216 includes a fibrous structure 218. As illustrated in FIG. 3, the second layer 216 is disposed directly adjacent to the first layer 212, e.g., with no intermediate (e.g., intervening) layer. A thermoplastic material 246 is imbibed through the second layer 216 (e.g., within at least a portion of the second layer 216) and along the first peripheral edge 250 and the second peripheral edge 254 of the filtration medium 208. The thermoplastic material is imbibed along the first and second peripheral edges 250 and 254, and within a limited extent of the cross-dimension 258 (FIG. 2) of the filtration medium 208. That is, the thermoplastic material 246 does not extend across the entire cross-dimension 258 of the filtration medium 208 (e.g., in a direction that is substantially transverse to the peripheral edges 250 and 254), as such a configuration may inhibit the filtration capability of the filtration medium 208 by completely blocking the flow of the fluid stream.

FIG. 2 and FIG. 3 illustrate one configuration of a filtration medium in accordance with the present disclosure. Those skilled in the art will recognize that other configurations may be utilized. For example, FIG. 4 illustrates a cross-section of a filtration medium 408 that includes an additional material layer, e.g., in relation to the embodiment illustrated in FIG. 2 and FIG. 3. In particular, the filtration medium 408 includes a first layer 412 including a porous membrane 414 and a second layer 416 including a fibrous structure 418. The first and second layers may be configured substantially as described above with respect to FIG. 2 and FIG. 3. In the embodiment illustrated in FIG. 4, the filtration medium 408 further includes a third layer 470. The third layer 470 may comprise, for example, a fibrous structure 472, such as a knit structure that is fabricated from strands of a fluoropolymer material such as PTFE. The fibrous structure 472 may be substantially similar to the fibrous structure 418 that is disposed on an opposite side of the first layer 412. As illustrated in FIG. 4, thermoplastic material 446a is imbibed through the third layer 470 and thermoplastic material 446b is imbibed through the second layer 416. In one characterization, one of the second and third layers may provide a support function for the first layer 412, while the other layer may provide a drainage function to facilitate drainage of fluid away from the first layer 412.

FIG. 5 illustrates a cross-section of another configuration of a filtration medium according to the present disclosure. In the configuration illustrated in FIG. 5, the filtration medium 508 includes a first layer 512 and a second layer 516 that is disposed on an opposite side of the first layer 512 from a third layer 570. The first, second and third layers may comprise materials and may be configured as described above with respect to the corresponding layers of FIGS. 2-4. Disposed between the second layer 516 and first layer 512 is a fourth layer 576. Likewise, disposed between the third layer 570 and the first layer 512 is a fifth layer 580. The fourth layer 576 and the fifth layer 580 (e.g., the intermediate layers) may comprise an open membrane, such as a fluoropolymer open membrane (e.g., PTFE). The open membrane may be a membrane that is highly porous that interfaces with and protects the first layer 512 (e.g., protects the porous fluoropolymer membrane).

As illustrated in FIG. 5, the thermoplastic material 546a and 546b is imbibed throughout the thickness of the filtration medium, e.g., throughout each of the first layer 512, the second layer 516, the third layer 570, the fourth layer 576 and the fifth layer 580. Alternatively, the thermoplastic material may be imbibed through only some of the layers, or may be imbibed only partially through any given layer, e.g., through a partial thickness thereof.

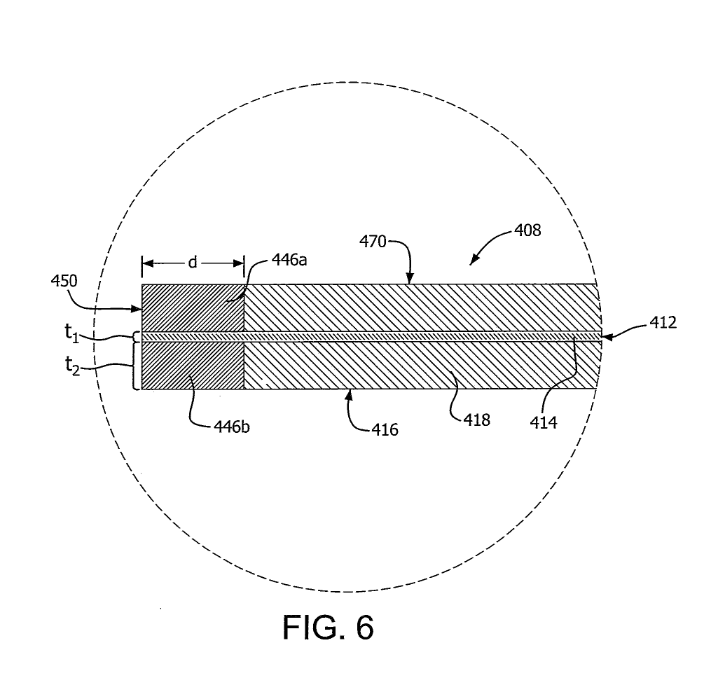

FIG. 6 illustrates another cross-sectional view of the filtration medium 408 illustrated in FIG. 4. As is described above, the filtration medium 408 includes a first layer 412 that includes a porous membrane 414. Disposed on opposite sides of the first layer 412 are a second layer 416 and a third layer 470. Each of the first and second layers 416, 470 may comprise a fibrous structure (e.g., fibrous structure 418) such as to provide support for the first layer 412 and/or to provide drainage away from the first layer 412 during use of the filtration medium 408.

A thermoplastic material 446b is imbibed through the second layer 416, and a thermoplastic material 446a is imbibed through the third layer 470. The thermoplastic materials 446a/446b are imbibed along a first peripheral edge 450 and within a cross-dimension of the filtration medium 408 by a distance d. For example, the distance d may be at least about 5 mm, such as at least about 10 mm or even at least about 25 mm. Further, as is described above, the thermoplastic materials 446a/446b should not be imbibed across the entire cross-dimension of the filtration medium 408. In one characterization, the distance d is not greater than about 100 mm, such as not greater than about 60 mm.

The thickness t₁ of the first layer 412 (e.g., the thickness of the porous membrane) may be selected to meet the requirements of the filtration application. For example, the thickness t₁, may be at least about 0.01 micrometers and not greater than about 100 micrometers. The thickness of the second and third layers (e.g., thickness t₂) may be at least about 25 micrometers, such as at least about 50 micrometers. Further, the thickness of the first and second layers may be not greater than about 380 micrometers, such as not greater than 150 micrometers. The first and second layers may have the same thickness or may have different thicknesses. Those skilled in the art will recognize that the dimensions of the filtration medium may be selected for particular filtration applications and particular configurations of a filtration device.

As illustrated in FIG. 6, the thermoplastic material 446a/446b is imbibed completely through the second layer 416 (e.g., completely through a thickness of the second layer 416) and completely through the third layer 470. It will be appreciated, however, that the thermoplastic material 446a/446b may be imbibed only partially through the layers, e.g., only partially through the thickness of the layers 416 and 470. Further, the thermoplastic material may be imbibed through all or a portion of the first layer 412, e.g., through the porous membrane.

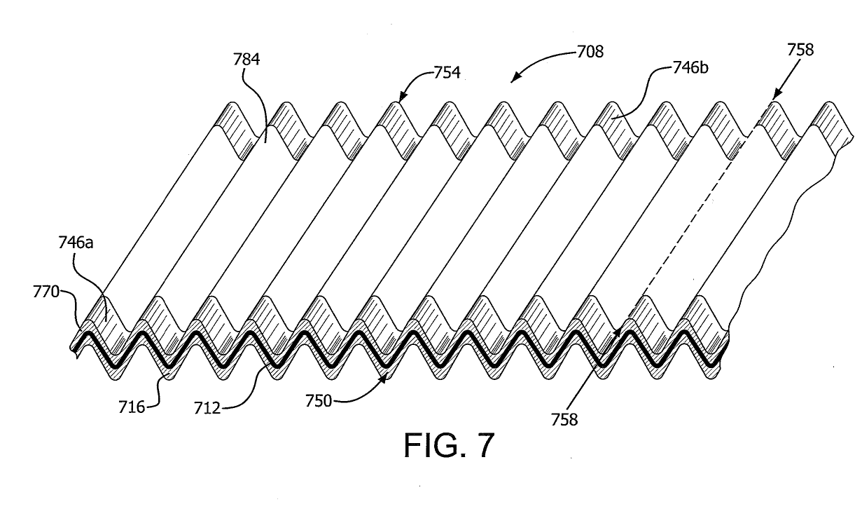

As is noted above, the filtration medium may be pleated to increase the effective surface area of the membrane. In this regard, FIG. 7 illustrates a perspective view of a pleated filtration medium according to one embodiment. The pleated filtration medium 708 includes a plurality of pleats (e.g., pleat 784) that extend along the cross-dimension 758 of the filtration medium 708, e.g., from the first peripheral edge 750 to the second peripheral edge 754. As may be appreciated, the utilization of a pleated configuration for the filtration medium provides for increased filtration capacity by increasing the effective size (e.g., area) of the filtration medium 708. In the embodiment illustrated in FIG. 7, the pleated filtration medium 708 includes outwardly-projecting pleats of an inverted, U-shaped configuration. In this regard, the pleats define U-shaped regions or valleys, between adjacent ones of the pleats about and along the filtration medium 708. Alternatively, the pleats may be of other configurations such as V-shaped pleats.

The pleated filtration medium 708 includes a thermoplastic material 746a imbibed along the first peripheral edge 750 and a thermoplastic material 746b imbibed along the second peripheral edge 754. The thermoplastic material 746a and 746b is imbibed within the filtration medium within a limited extent of the cross-dimension 758 of the filtration medium. Further, the thermoplastic material (e.g., thermoplastic material 746a) is imbibed through at least the second layer 716 and the third layer 770 of the filtration medium 708. The thermoplastic material 746a may also be imbibed through the first layer 712 that is disposed between the second and third layers (e.g., through the membrane).

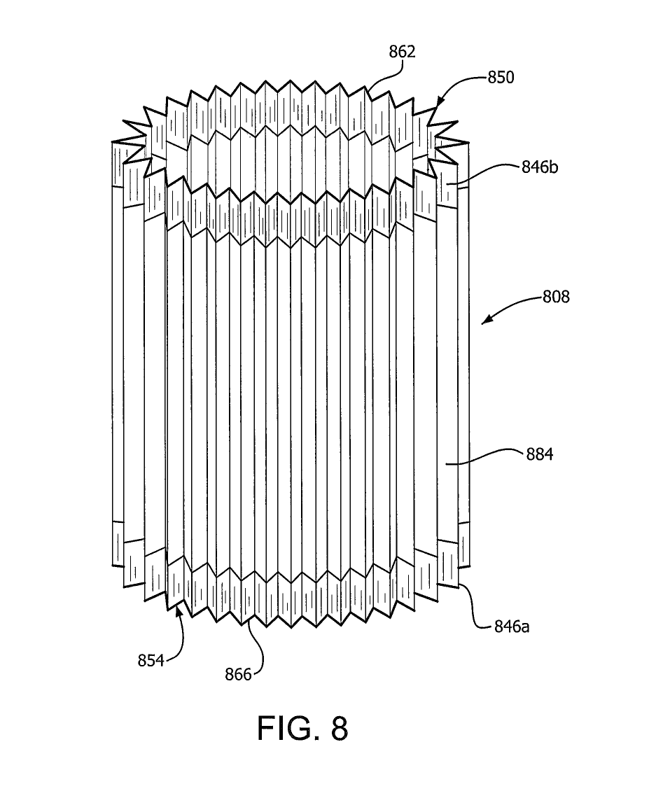

FIG. 8 illustrates a pleated filtration medium 808 in accordance with another embodiment. The filtration medium 808 is in the form of a closed cylinder having a first peripheral edge 850 at a first end 862 of the filtration medium 808 and a second peripheral edge 854 disposed at a second end 866 of the filtration medium 808. Thermoplastic materials 846a and 846b are imbibed along the first peripheral edge 850 and second peripheral edge 854. As illustrated in FIG. 8, the pleats (e.g., the pleat 884) have a V-shaped configuration.

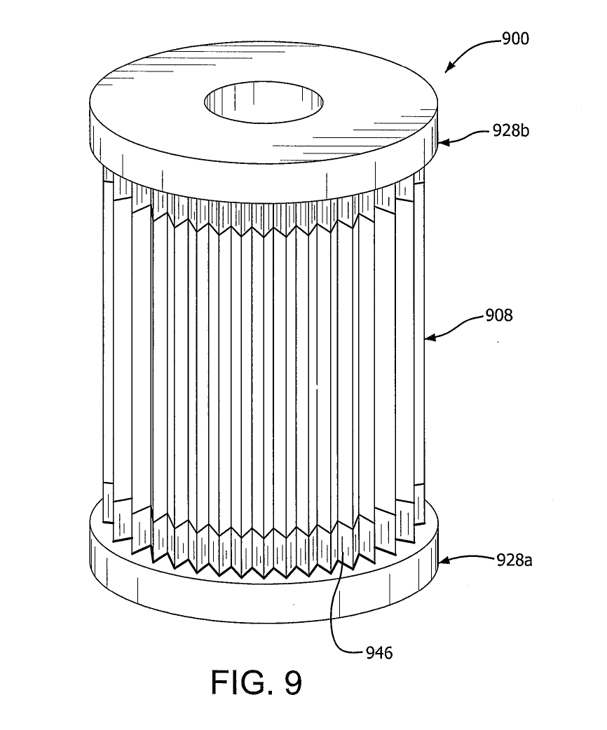

FIG. 9 illustrates a filtration article in accordance with an embodiment, namely a filtration cartridge 900 comprising a filtration medium 908 and end cap components 928a and 928b that are potted onto the ends of the filtration medium 908. The filtration medium 908 includes a thermoplastic material 946 that assists in the formation of a high integrity seal between the filtration medium 908 and the end cap component 928a. As illustrated in FIG. 9 the thermoplastic material 946 is imbibed within the filtration medium 908 (e.g., within a cross-dimension of the filtration medium 908) past (e.g., beyond) the end cap component 928a. That is, to ensure a complete and high integrity seal between the filtration medium 908 and the end cap component 928a, the thermoplastic material 946a may be imbibed within the cross-dimension to a distance that extends beyond the end cap component 928a when the end cap component 928a is potted onto the filtration medium 908. A similar configuration may be utilized with respect to potted end cap component 928b.

The present disclosure also provides methods for fabrication of filtration articles such as those disclosed above. The method may include imbibing a filtration medium with a thermoplastic material along a first peripheral edge of the filtration medium and within a limited extent of a cross-dimension of the filtration medium. Thereafter, the filtration medium may be potted in a thermoplastic end cap component along the first peripheral edge.

The thermoplastic material may be imbibed within the filtration medium using a variety of methods. In one embodiment, the thermoplastic material is contacted with the filtration medium along the first peripheral edge, such as where the thermoplastic material is in the solid state. The thermoplastic material may then be heated (e.g., above its melting point) such that the thermoplastic material may flow and imbibe the first peripheral edge. For example, the contacting step may include disposing a strip of the thermoplastic material along the peripheral edge in a continuous or semi-continuous process. The strip of thermoplastic material may have a width of at least about 5 mm, such as at least about 10 mm or even at least about 25 mm. However, as is noted above, sufficient area of the filtration medium should be unimpeded by the thermoplastic material. In this regard, the strip may have a width of not greater than about 100 mm, such as not greater than about 60 mm.

In another embodiment, the contacting step may include co-extruding the thermoplastic material with the filtration medium. That is, the filtration medium (e.g., the membrane and the additional layers) may be formed by extrusion, and the thermoplastic material may be co-extruded with the remaining components of the filtration medium in a continuous manner.

Before potting the filtration medium in the thermoplastic end cap component, the filtration medium may be pleated to increase the effective surface area of the filtration medium. For example, the pleating step may include heating the filtration medium and the thermoplastic material using heated platens during the pleating step. Heated platens may advantageously plastically deform the thermoplastic material during the heating step. In this regard, when the filtration medium, including the thermoplastic material imbibed along one or both edges of the filtration medium is cooled, the thermoplastic material may advantageously maintain the pleats in the filtration medium, i.e., may advantageously assist in maintaining the pleated structure during subsequent operations, Before the potting step, the heated thermoplastic material may be allowed to cool to a temperature below the melting temperature of the thermoplastic material.

Thereafter, the filtration medium may be formed into a cylindrical configuration, such as by adhering opposite ends of the filtration medium to form a closed cylinder. End cap components may then be potted onto the filtration medium by heating the end cap components to a temperature that is sufficient to soften the end cap components such that the end cap component will imbibe the filtration medium when contacted with the filtration medium. For example, the thermoplastic end cap component may be heated to or slightly above its melting point when the end cap component is contacted with the filtration medium. In one characterization, the thermoplastic end cap component is heated to a temperature of at least about 150° C., such as at least about 200° C. or even at least about 250° C. The filtration medium is then contacted with the end cap component and the assembly is then allowed to cool to form a high integrity seal between the end cap component and the filtration medium. See FIG. 9.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A filtration article for filtration of particles from a fluid stream, comprising:
a filtration medium having at least a first peripheral edge, the filtration medium comprising:
a first layer, positionable across said fluid stream, comprising a porous fluoropolymer membrane; and
a second layer, positionable across said fluid stream, comprising a plurality of fluoropolymer fibers arranged to form a fibrous structure, the fibrous structure being selected from a woven structure, a nonwoven structure, and a knit structure, and
a thermoplastic material imbibed through at least a portion of a thickness of said second layer fibrous structure along said first peripheral edge, and within a limited extent of a cross-dimension of said filtration medium; and
a thermoplastic end cap component potted onto said filtration medium along said first peripheral edge.

2. The filtration article recited in claim 1, wherein said filtration medium is pleated.

3. The filtration article recited in claim 1, wherein said filtration medium is configured as a closed cylinder.

4. The filtration article recited in claim 1, wherein said thermoplastic material is imbibed in a continuous fashion along said first peripheral edge.

5. The filtration article recited in claim 1, wherein said peripheral edge corresponds with a first end of said filtration medium.

6. The filtration article recited in claim 5, wherein a second peripheral edge is imbibed with said thermoplastic material through at least a portion of said thickness of said second layer fibrous structure and within a limited extent of the cross-dimension of said filtration medium.

7. The filtration article recited in claim 6, wherein said second peripheral edge corresponds with a second end of said filtration medium that is opposite said first end of said filtration medium across said cross-dimension.

8. The filtration article recited in claim 1, wherein said porous fluoropolymer membrane comprises PTFE.

9. The filtration article recited in claim 1, wherein said thermoplastic material comprises FEP.

10. The filtration article recited in claim 1, wherein said thermoplastic material comprises PFA.

11. The filtration article recited in claim 1, wherein said thermoplastic end cap comprises PFA.

12. The filtration article recited in claim 1, wherein said second layer is positioned adjacent to and downstream of said first layer to provide for at least support of said first layer.

13. The filtration article recited in claim 1, wherein said filtration medium further comprises a third layer, positionable across said fluid stream, disposed on an opposite side of said membrane from said second layer and comprising a plurality of fluoropolymer fibers arranged to form a fibrous structure, the fibrous structure being selected from the group consisting of a woven structure, a nonwoven structure and a knit structure.

14. The filtration article recited in claim 13, wherein said thermoplastic material is imbibed through at least a portion of a thickness of said third layer fibrous structure along said first peripheral edge.

15. The filtration article recited in claim 1, wherein said thermoplastic material is imbibed substantially throughout said thickness of said second layer fibrous structure.

16. The filtration article recited in claim 1, wherein said thermoplastic material is imbibed within said cross-dimension of said filtration medium by a distance of at least about 5 mm.

17. The filtration article recited in claim 1, wherein said thermoplastic material is imbibed within said cross-dimension of said filtration medium by a distance of not greater than about 100 mm.

18. The filtration article recited in claim 1, wherein said thermoplastic material is imbibed within said cross-dimension past said thermoplastic end cap.

19. The filtration article recited in claim 1, further comprising:
a thermoplastic material imbibed through at least a portion of a thickness of said second layer fibrous structure along a second peripheral edge, and
a second thermoplastic end cap component potted onto said filtration medium along said second portion of said peripheral edge.

20. The filtration article recited in claim 1, wherein a melting point of said thermoplastic material is less than a melting point of said thermoplastic end cap component.

21. The filtration article recited in claim 1, wherein a melting point of said thermoplastic material is not greater than about 300° C.

22. The filtration article recited in claim 1, wherein the filtration medium is configured to remove particles having a size of about 25 nm and greater from said fluid stream.

23. The filtration article recited in claim 1, wherein the second layer fibrous structure is a knit structure.

24. The filtration article recited in claim 14, wherein the third layer fibrous structure is a knit structure.

25. The filtration article recited in claim 19, wherein the second layer fibrous structure is a knit structure.

26. A filtration device comprising a filter cage and a filter element disposed within said filter cage, said filter element comprising the filtration article recited in claim 1.

27. A method for the manufacture of a filtration article, comprising the steps of:
imbibing a filtration medium having at least a first peripheral edge with a thermoplastic material along said first peripheral edge and within a limited extent of a cross-dimension of said filtration medium;
potting said filtration medium in a thermoplastic end cap component along said first peripheral edge.

28. The method recited in claim 27, wherein said filtration medium comprises:
a first layer, positionable across a fluid stream, comprising a porous fluoropolymer membrane; and
a second layer, positionable across said fluid stream, comprising a plurality of fluoropolymer fibers arranged to form a fibrous structure, the fibrous structure being selected from a woven structure, a nonwoven structure and a knit structure.

29. The method recited in claim 28, wherein said second layer fibrous structure is a knit structure.

30. The method recited in claim 27, wherein said imbibing step comprises the steps of:
contacting said filtration medium with said thermoplastic material along said first peripheral edge; and
heating said thermoplastic material to imbibe said first peripheral edge with said thermoplastic material.

31. The method recited in claim 30, wherein said contacting step comprises disposing a strip of said thermoplastic material along said peripheral edge and in contact with said second layer.

32. The method recited in claim 31, wherein said strip has a width of at least about 5 mm and not greater than about 100 mm.

33. The method recited in claim 30, wherein said contacting step comprises co-extruding said thermoplastic material with said filtration medium.

34. The method recited in claim 27, further comprising the step of, before said potting step, pleating said filtration medium.

35. The method recited in claim 34, wherein said heating step comprises heating said filtration medium and said thermoplastic material using heated platens during said pleating step.

36. The method recited in claim 35, wherein said heated platens plastically deform said thermoplastic material during said heating step.

37. The method recited in claim 30, wherein said heating step comprises heating said thermoplastic material to a temperature in excess of the melting temperature of said thermoplastic material.

38. The method recited in claim 37, further comprising, before said potting step, allowing said heated thermoplastic material to cool to a temperature below the melting temperature of the thermoplastic material.

39. The method recited in claim 28, wherein said porous fluoropolymer membrane comprises PTFE.

40. The method recited in claim 39, wherein said thermoplastic material is FEP.

41. The method recited in claim 39, wherein said end cap component is PFA.

42. The method recited in claim 27, wherein said potting step creates a seal between said end cap component and said filtration medium.

43. The method recited in claim 27, further comprising the steps of:
imbibing said filtration medium with said thermoplastic material along at least a second peripheral edge of said filtration medium and within a limited extent of said cross-dimension of said filtration medium; and
potting said filtration medium in a second thermoplastic end cap component along said second peripheral edge.
